(19) United States
(12) Patent Application Publication
(10) Pub. No.: US 2002/0169848 A1
(43) Pub. Date: Nov. 14, 2002

(54) Apparatus for downloading documentation

(76) Inventor: Marcos Esterman JR., Boise, ID (US)

Correspondence Address: HEWLETT-PACKARD COMPANY, Intellectual Property Administration, P.O. Box 272400, Fort Collins, CO, 80527-2400, US

(21) Appl. No.: 09/852,875

(22) Filed: May 10, 2001

(51) Int. Cl. G06F 15/16

(52) U.S. Cl. 709/217

(57) ABSTRACT

An apparatus for obtaining product documentation is attached to the product, and has a memory, an activation switch, and a transmitter. Upon activation, the transmitter retrieves document download instructions stored in the memory, and transmits the instructions via a short range wireless protocol to a portable processor based device. The processor based device then executes the document download instructions, with the result that the device is caused to connect to a data network, locate a specified data file, and download the data file.

### FIELD OF THE INVENTION

The present invention is directed to an apparatus for downloading documentation. More particularly, the present invention is directed to an apparatus and a computer program for transmitting instructions to a networked device for downloading documentation over the network.

### BACKGROUND OF THE INVENTION

Commercially provided products are often accompanied by documentation. An owner's manual and a warranty document are common examples of documentation that accompany a product when purchased. The purchaser should store these documents for reference during the lifetime of the product. This has proved inconvenient and burdensome, particularly for products with voluminous documentation and/or with long lifetimes.

Documentation for products such as manuals, warranties, service instructions and the like may change during a product lifetime. Such changes require users to update their documentation to avoid having out-of date documentation, which places additional burdens on users. Likewise, product manufacturers and sellers may be faced with the burden of supplying users with documentation updates as they come available. This disadvantageously requires the manufacture and/or seller to maintain up to date customer contact information, and to go through the expense and effort of regularly producing and transmitting document updates to users whenever they become available.

General solutions to these problems have been proposed. For instance, it is possible to provide the documentation in downloadable format on a network based library or repository. Users may simply download documents when needed from the network based source, thereby reducing the burden associated with storing and updating information. Also, manufacturers and sellers may provide documents in digital format at the network source, thus reducing the need to print documents, to keep track of users, and to regularly provide users with updated documents. An example of such a solution is presented in U.S. Pat. No. 5,913,210 issued to Call. Such solutions, however, have introduced new sets of problems.

For instance, users are required to store the network address through the product's lifetime. This address may prove easier to store than the documents themselves, but it nonetheless introduces a burden. Also, network addresses can be complex and require some degree of user computer and network knowledge. Addresses on the popular World Wide Web, for instance, are comprised of up to four parts: a protocol, a domain name, a path, and a filename. The address for a popular Yahoo! Corp. financial information portal on the Web, for example, has the address: //login.yahoo.com/config/login.src=quote&.intl=us&.done=http://finance.yahoo.com Additionally, a user may be required to have information regarding the product such as model number, serial number, purchase date, purchase location, and the like that requires the creation and storage of document records.

These and other heretofore-unresolved problems exist in the art.

### SUMMARY OF THE INVENTION

The present invention is directed to an apparatus for initiating a document download. The apparatus generally comprises a memory with document download instructions stored therein, a transmitter for transmitting the document download instructions via a wireless protocol, and an activation switch for causing the transmitter to transmit the document download instructions. Preferably, the apparatus further comprises a shell having attachment means for attaching the apparatus to a product.

The apparatus of the invention may thus be attached to a product and be activated through the activation switch means to initiate a download of a document corresponding to the product. Advantageously, the product thereby need not be a networked product, and for that matter need not be an electronic product. By way of example, one embodiment of an apparatus of the invention may comprise a small apparatus attached to the underside of a chair. To obtain a document such as an owner's manual for the chair, a user may activate the activation switch on the apparatus, with the result that document download instructions will be transmitted from the apparatus of the invention. The user may receive this signal with a portable processor based device such as a portable laptop computer, or the like. The document download instructions when executed by the laptop will locate the desired document at a specified network address, and will download the document to the processor-based device. Thus, with a single action of activating a switch means on the apparatus the user will have an owner's manual displayed on his laptop.

Those knowledgeable in the art will appreciate that the present invention lends itself well to practice in the form of a computer program product. It will therefore be appreciated that an additional embodiment of the present invention comprises a computer program product, with a more detailed description to be presented herein below.

The various embodiments of the present invention thereby solve many of the heretofore-unresolved problems in the art in a novel and elegant manner. For example, products may be provided without accompanying paper documentation, which instead may be provided on a most recently available version over a network for on-demand downloading without requiring a high level of computer knowledge on the part of users. Product users are thereby saved the effort of storing and keeping track of the current version of documentation without having to keep track of a network address or of instructions for navigating a company website or the like.

The above brief description sets forth broadly the more important features of the present disclosure so that the detailed description that follows may be better understood, and so that the present contributions to the art may be better appreciated. There are, of course, additional features of the disclosure that will be described hereinafter that further describe the subject matter of the invention. In this respect, before explaining embodiments of the disclosure in detail, it is to be understood that the disclosure is not limited in its application to the details set forth in the following description or illustrated in the drawings. The present invention is capable of other embodiments, as will be appreciated by those skilled in the art. Also, it is to be understood that the phraseology and terminology employed herein are for description and not limitation.

### BRIEF DESCRIPTION OF THE DRAWINGS

FIG. 1 is a schematic diagram of an embodiment of an apparatus of the invention.

FIG. 2 is a perspective view of an embodiment of an apparatus of the invention.

FIG. 3 is a bottom plan view of an embodiment of an apparatus of the invention.

FIG. 4 is a schematic illustrating operation of an embodiment of an apparatus of the invention.

FIG. 5 is a schematic illustrating operation of an embodiment of an apparatus of the invention.

FIG. 6 is a perspective view of an apparatus of the invention installed on a table.

FIG. 7 is a perspective view of an apparatus of the invention installed on a speaker.

FIGS. 8(a) and (b) show a flow chart illustrating an embodiment of a program product of the invention.

### DETAILED DESCRIPTION

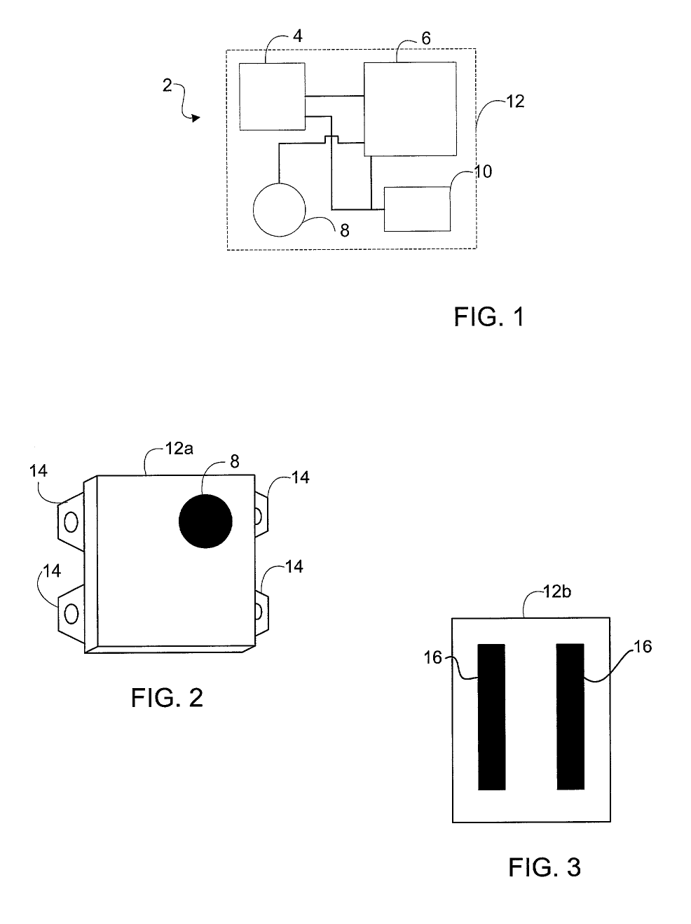

Turning now to the drawings, FIG. 1 is a schematic of one embodiment of an apparatus 2 of the invention. The apparatus 2 comprises a memory 4, a wireless protocol transmitter 6 linked to the memory 4, an activation switch means 8 linked to the transmitter 6, a power supply 10 linked to the memory 4 and the transmitter 6. The various modules and components are contained within the shell 12.

The memory 4 may be any suitable device for storing digital data as may be available, including but not limited to circuitry, integrated circuitry, chips or chipsets, magnetic media such as disks, optical media such as disks, and the like. The transmitter 6 comprises a means for transmitting data via a wireless protocol, preferably over an operable range of not more than about 10 meters. Such means are known, with preferred examples comprising radio frequency (“RF”) modules and infrared (“IR”) modules. With greater particularity, the Blue Tooth protocol provides for RF transmissions over an operable range of not more than about 10 meters, while IR protocols such as those used with handheld PDA's and laptops support transmission over a range of not more than about 3 meters. Bluetooth is a wireless protocol standard developed by an industry consortium made up of 3Com, Ericsson, IBM, Intel, Lucent, Microsoft, Motorola, Nokia, and Toshiba. More information, including protocol specifications, can be obtained on the Bluetooth website: www.bluetooth.com, with the contents thereof incorporated herein by reference.

Activation switch means 8 may comprise any of a multiplicity of switch means as may be available. Examples include, but are not limited to, mechanical switches such as push buttons, levers, rocker switches, and the like; and passive input receivers such as an IR detector, RF receiver, and the like. Power supply 10 preferably comprises a DC power supply such as a battery or the like, so that the apparatus 2 may be self-contained. That is, a DC battery type power supply 10 is preferred so that no external wiring is required for powering the apparatus 2.

Preferably, at least one of the modules or components of the apparatus 2 comprises a processor capable of processing computer executable instructions. Alternatively, the apparatus 2 may comprise an additional stand-alone processor or microprocessor for controlling the operation of the various modules of the apparatus 2. The instructions to be executed by the processor of the apparatus 2 are anticipated to be limited in scope. Accordingly, only limited processing power is required. There are a wide variety of commercially available components that provide such processing power, often in combination with other components. As a representative example, processor functionality may be combined with transmitter functionality, memory functionality, and/or switch functionality. The schematic of FIG. 1 has been illustrated assuming such a combination, with a stand-alone processor thereby not illustrated. It may be assumed with reference to FIG. 1 that the transmitter 6 comprises processor capabilities.

Also, it is noted that although the linkage scheme of one embodiment of an apparatus of the invention has been illustrated in the schematic of FIG. 1, many other linkage schemes will be able to be practiced within the scope of the invention as claimed. By way of example, the activation switch 8 could be linked to the memory 4 or to the power supply 10. Also, the individual modules as illustrated in FIG. 1 could be replaced with functional components that combine the function of one or more of the components. Again by way of example, a single combination transmitter/memory/power supply component could replace the individual components 4, 6, and 10, respectively. Indeed, all functional components could be combined in a single circuit or chipset. Those knowledgeable in the art will thereby appreciate that a multiplicity of variations on the schematic of FIG. 1 are possible within the scope of the invention as claimed.

FIG. 2 is a top perspective view of a first embodiment 12a of the shell 12 of the apparatus of the invention. The shell 12a is preferably small in dimension for convenient placement on products. Preferably, the shell 12a comprises dimensions of less than 1 inch in length, height, and width. The shell 12a is preferably “closed” to protect the inner components and modules from heat, moisture, cold, and breakage. Although “closed”, the shell 12a comprises a passage for access to the activation switch 8, and may further provide a passage for transmission of the transmitter 6 wireless signal. Preferably these passages are sealed to an extent required to provide reasonable protection from the elements.

The apparatus of the invention is directed to providing initiation of a document download. That is, the invention is directed to providing a tool for obtaining documentation for a particular product. An embodiment of the apparatus of the invention will be attached to a product, so that the apparatus is always proximate the product. Accordingly, the shell 12 preferably comprises means for attachment to a product, such as the feet 14 of the shell 12a embodiment. The feet 14 have holes therein for passing locking screws or other like members. It will be appreciated that the feet 14 are thereby preferred for use for secure attachment to wood products or other products that allow for penetration by a screw or the like. The bottom plan view of a second embodiment 12b of the shell 12 shows alternate attachment means in the form of adhesive strips 16. Such strips may be preferred for products for which locking screws are not practical such as thin plastic products, sensitive electronics, and the like.

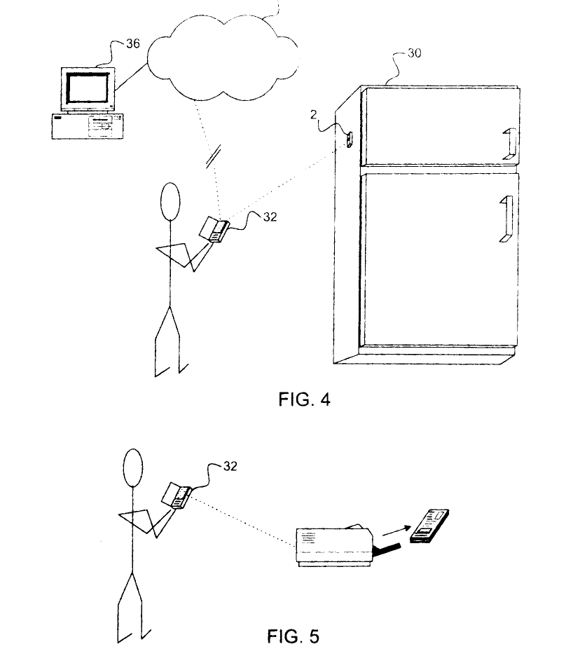

Once attached to a product, the apparatus of the invention may be operated to initiate a document download for the product. With reference simultaneously to FIGS. 1 and 4, the apparatus 2 may be attached to a product such as a refrigerator 30. When activation switch 8 is activated, for example by being mechanically pressed or through receiving a wireless prompt from a processor based personal digital assistant (“PDA”) 32, it sends a prompt to the transmitter 6. After receiving the prompt, the transmitter 6 retrieves a “document download instructions” stored in memory 4. A “document download instructions” as used herein is intended to refer to at least a network address for a data file, and more preferably refers to a set of processor executable instructions for locating a specified data file on a network at a network address, and for downloading the data file.

An example of a download instructions comprise instructions for causing a processor-based device to connect to the World Wide Web, to obtain a data file at a specified URL address on the Web, and to download the data file. As will be appreciated by those knowledgeable in the art, the instructions may be created using any number of different application programming tools that are available, and that preferably feature interface functionality with operating systems and web browsers. The download instructions may further preferably comprise information regarding the product that can be used to locate specific document sets. As an example, the instructions may comprise a unique product identifier such as a product serial number. When transmitted to the data network, this serial number may trip a flag indicating that recall documents or other information that is specific to the particular product is available for download.

The result of execution of the download instructions is generally illustrated in FIG. 4. After receiving the instructions from the apparatus 2 via a wireless transmission, the user's PDA 32 is caused to connect to a network 34, to locate a data file (which may for instance correspond to the most recent refrigerator 30 owner's manual) that is stored at a particular network address on a network accessible storage device such as a computer 36, and to download the data file. Once downloaded, the user may choose to view the manual on screen, or may choose to print it as generally illustrated by FIG. 5. Alternatively, an embodiment of the download instructions of the apparatus of the invention further comprises instructions for automatically transmitting the data file once obtained via wireless transmission to a printer for printing.

In still an additional embodiment of the apparatus of the invention, the download instructions is transmitted from the apparatus 2 directly to a networked printer device for execution. This particular embodiment of the download instructions when executed by the processor based printer causes the printer to obtain the desired data file on the connected network, to download the document, and to print the document. This embodiment thereby eliminates the processor-based device “between” the product and the printer.

It can thus be seen that the various embodiments of the apparatus of the invention provide for obtaining a specified document with very little burden or required action on the part of the user. For example, the user is not required to store any articles or information regarding the product. Additionally, no particular level of computer or network skills are required, as the user is merely required to activate the activation switch on the apparatus of the invention while a processor based device capable of interfacing with the apparatus is nearby. In general summary, the apparatus of the invention allows for a user to obtain a most recently available document upon a single action of activating the apparatus.

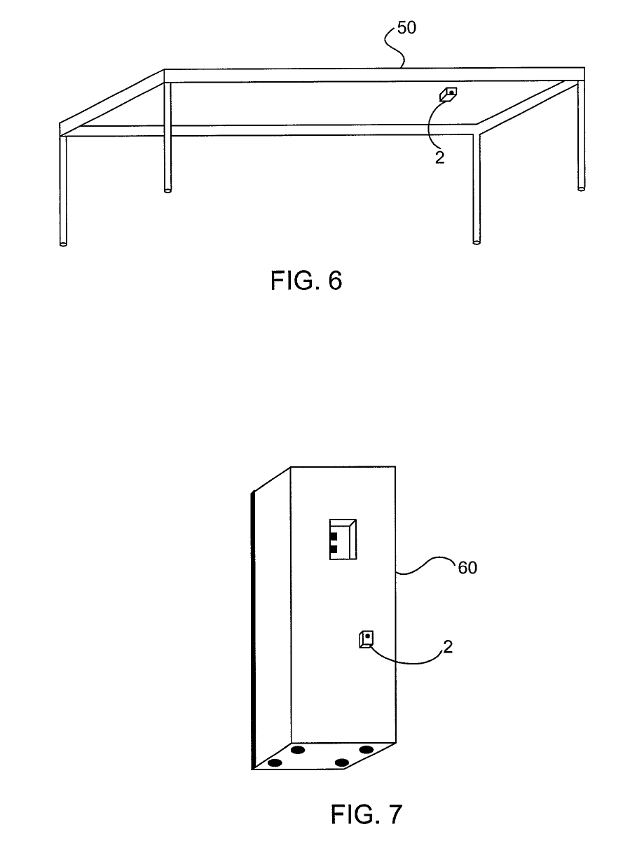

It is anticipated that the apparatus of the invention may have greatest utility when practiced with non-network connectable devices. That is, it is theorized that the apparatus of the invention is not likely required for devices such as PDA's, computers, cellular telephones, or the like as they may have functionality for storage of a download instructions and for direct connection to a network in and of themselves. Accordingly, it is further theorized that the apparatus of the invention will have great utility with products that have needs for documentation, and that have a relatively long service life. Representative examples, include, but are not limited to, furniture such as chairs and tables (illustrated as the table 50 in FIG. 6), stereo speakers (illustrated as the speaker 60 in FIG. 7), lawn mowers, motor vehicles, appliances such as washers and stoves, power tools, machine tools, industrial equipment, and the like.

Those knowledgeable in the art will appreciate that the present invention also lends itself well to practice in the form of a computer program product. Accordingly, it will be appreciated that additional embodiments of the present invention comprise computer program products comprising computer executable instructions embedded in a computer readable medium that when executed cause the computer to take prescribed actions. Preferred examples of computer readable mediums comprise, but are not limited to, magnetic media, optical media, chips, and circuitry. Also, as used herein, the term “computer” is intended to refer to any processor-based device capable of executing instructions.

One computer program product of the invention comprises a program product for operating the apparatus of the invention. With reference to FIG. 4 in particular, this program product embodiment comprises executable instructions embedded in a memory device such as the memory 4 for controlling the apparatus 2. The instructions will cause the transmitter 6 to retrieve document download instructions after receiving a prompt from the activation switch 8, and to transmit the document download instructions via a short range wireless protocol. The document download instructions comprise the same processor executable instructions as described with reference to the apparatus 2 as discussed herein above. In general, the instructions comprise processor executable instructions for causing a processor-based device to locate and download a data file at a specified network address.

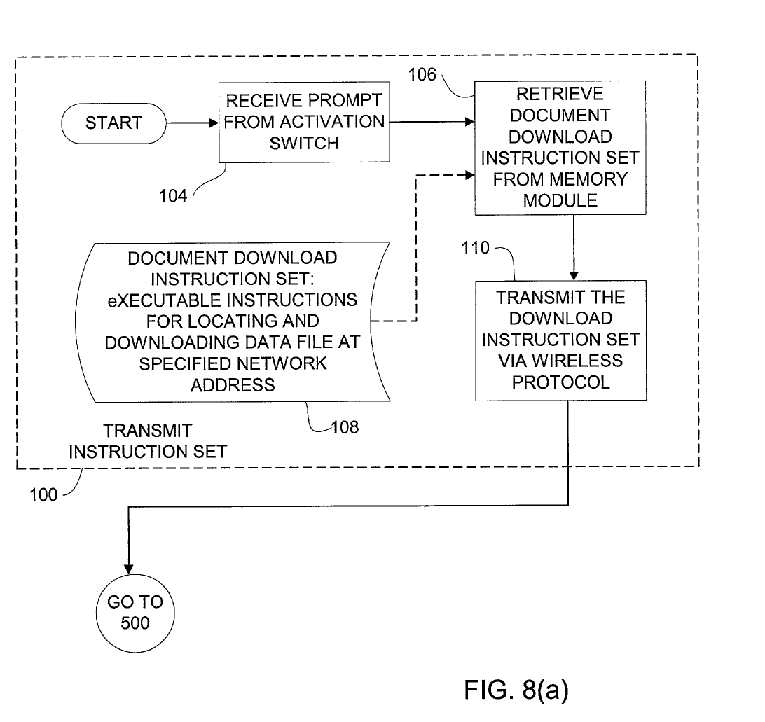

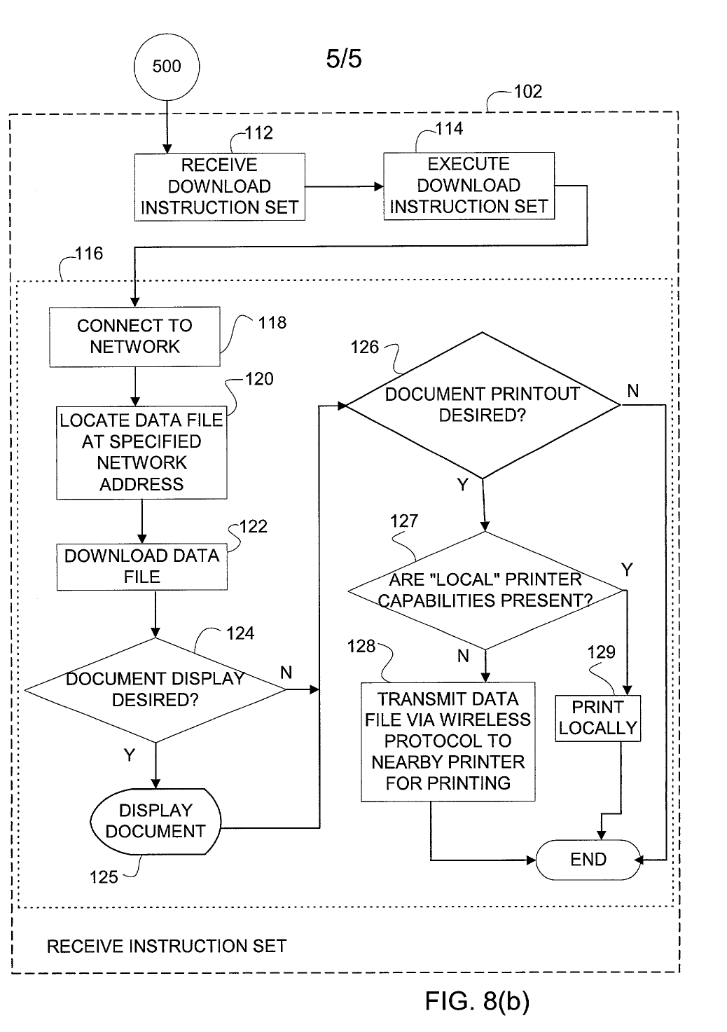

A second embodiment of a computer program product of the invention is described in the flow-chart of FIGS. 8(a)-8(b). This program product is generally organized into two instructions sets, a “transmit” instruction set 100 of FIG. 8(a), and a “receive” instruction set 102 of FIG. 8(b). Generally, the transmit instruction set 100 is executed by the apparatus 2 of the invention, while the receive instruction set is executed by a processor based device such as the PDA 32 of FIG. 2. Accordingly, this embodiment of the program product of the invention comprises executable instruction sets on two separate devices.

The transmit instruction set 100 has an initial step of receiving a prompt from an activation switch (block 104). After receiving the prompt, the instruction set causes the apparatus to retrieve a document download instruction set stored on a memory (block 106). The document download instruction set (block 108) is as described as herein above, and generally comprises an instruction set for execution by a processor based device to cause the device to locate and download a data file from a network. Finally, the transmit instruction set causes the apparatus 2 to transmit the download instruction set via a wireless protocol (block 110). Preferably, the wireless protocol has an operating range of not more than about 10 meters, and most preferably not more than about 3 meters.

The receive instruction set 102 of FIG. 8(b) when executed by a processor based device such as a PDA will cause the device to receive the download instruction set (block 112) after it has been transmitted by the transmit instruction set being executed by the apparatus 2, and to subsequently execute the download instruction set (block 114). The download instruction set execution will cause the device to carry out various actions, with these actions represented as the blocks within the group illustrated within the dashed line 116 of FIG. 8(b).

As a first action, execution of the download instruction set will cause the processor-based device to connect to a network (block 118). As will be appreciated, this action may comprise causing the device to start a browser or other program application, and/or to access a network provider service such as an internet service provider. Once connected to the network, the instruction set will cause the device to locate a specified data file at a specified network address (block 120). The data file preferably corresponds to a document, such as a product owner's manual or the like. The instruction set next causes the processor-based device to download the data file (block 122).

Once downloaded to the device, the instruction set causes the device to offer the user with a choice of displaying and/or printing the document (blocks 124, 126). The instruction set will cause the device to display the document on screen (block 125) if desired. If the user chooses to print the document, the instruction set causes the processor-based device to determine whether “local” printer capabilities exist (block 127). As used herein, “local” capabilities are intended to refer to directly connected or internal capabilities. As an example, if the processor-based device comprised a printer instead of a PDA, or a computer with a printer installed on and connected thereto, it would have “local” printer capabilities. If such local capabilities exist, the instruction set causes the document to be printed (block 129). If not, the instruction set will cause the processor based device to transmit the data file via a wireless protocol signal to a nearby printer for printing (block 128), with an example generally illustrated in the schematic of FIG. 5.

It will be appreciated by those knowledgeable in the art that the various computer program product embodiments of the invention solve many problems left otherwise unresolved in the art. As with the apparatus of the invention, the computer program product embodiments generally operate to obtain with minimal user action a most recently available document for a product. No document or information storage burdens are placed on the user. Likewise, the user is not required to have any particular level of computer or network skills to navigate a computer network.

The advantages of the disclosed invention are thus attained in an economical, practical, and facile manner. While preferred embodiments and example configurations have been shown and described, it is to be understood that various further modifications and additional configurations will be apparent to those skilled in the art. For example, the sequence of program steps illustrated herein is not exclusive, as the program product of the invention may cause various actions to occur in an order different from that illustrated herein. Also, the various components of the apparatus of the invention may be combined or linked to one another in a manner different than that described herein. It is intended that the specific embodiments and configurations herein disclosed are illustrative of the preferred and best modes for practicing the invention, and should not be interpreted as limitations on the scope of the invention as defined by the appended claims.

What is claimed is:

1. An apparatus for initiating a document download comprising:
a memory with document download instructions stored therein;
a wireless transmitter linked to said memory for transmitting download instructions via a wireless protocol; and
an activation switch for causing said wireless transmitter to retrieve said document download instructions from said memory and to transmit said instructions.

2. An apparatus as defined by claim 1 wherein said document download instructions comprise at least a network address corresponding to a network based document source.

3. An apparatus as defined by claim 2 wherein said network address comprises an internet protocol address corresponding to a data file containing a document.

4. An apparatus as defined by claim 1 wherein said download instructions comprise computer executable instructions for execution by a processor based device to cause said processor based device to locate a data file on a network at a network address as specified by said download instructions and to download said data file to said processor based device.

5. An apparatus as defined by claim 4 wherein said processor based device comprises a printer connected to a network, and wherein said download instructions further comprises computer executable instructions for printing a document contained in said data file.

6. An apparatus as defined by claim 1 wherein said wireless protocol has an operating range of 3 meters or less.

7. An apparatus as defined by claim 1 wherein said apparatus further comprises a power supply for powering said memory and said transmitter.

8. An apparatus as defined by claim 7 wherein said power supply comprises a DC power source.

9. An apparatus as defined by claim 1 wherein said apparatus further comprises a shell containing said memory and said transmitter, said shell having a passage for operable access to said activation switch, attachment means connected to said shell for attaching said shell to a product.

10. An apparatus as defined by claim 1 wherein said activation switch comprises a signal receiver for receiving a signal from a portable processor based device.

11. An apparatus as defined by claim 1 wherein said memory further comprises a unique product identity code stored therein, said unique identity code transmitted with said download instructions by said transmitter.

12. An apparatus for causing a processor based device to download a document, the apparatus connectable to a product, the apparatus comprising:
a memory with document download instructions stored therein, said document download instructions comprising processor executable instructions for causing the processor based device to locate a data file stored on a network accessible storage device, said data file containing a document corresponding to the product, said instructions for causing said processor based device to download said data file from said storage device to the processor based device;
a short range wireless transmitter linked to said memory for transmitting said download instructions via a wireless protocol to the processor based device, said wireless transmitter having an operable range of not more than about 10 meters;
a DC power source linked to said memory and linked to said transmitter, said DC power source for powering said memory and said transmitter;
a shell containing said memory, said DC power source, and said transmitter, said shell having connection means for connection to the product; and,
an activation switch for causing said wireless transmitter to transmit said document download instructions to the processor based device, said activation switch penetrating said shell.

13. A computer program product for causing an apparatus to initiate a document download, the computer program product comprising computer executable instructions stored in a computer readable medium, the instructions when executed causing the apparatus to:
detect a prompt from activation of an activation switch;
retrieve document download instructions from a memory linked to said activation switch after receiving said prompt; and, transmit said document download instructions from a transmitter via a wireless protocol.

14. A computer program product as in claim 13 wherein execution of said instructions to cause the apparatus to transmit said document download instructions further comprises causing said transmitter to transmit said download instructions via a short range wireless protocol having an operable range of less than about 3 meters to a processor based device.

15. A computer program product as defined by claim 13 wherein said download instructions comprise computer executable instructions for execution by a processor based device to cause said processor based device to locate a document on a network and to download said document to said processor based device.

16. A computer program product as defined by claim 13 wherein execution of the program instructions to cause the apparatus to receive a prompt further comprises causing the apparatus to receive a transmit signal from a processor based device with activation switch means comprising a signal receiver port.

17. A computer program product for causing an apparatus to initiate a document download, the computer program product comprising computer executable instructions stored in a computer readable medium, the instructions when executed causing the apparatus to:
detect a prompt from an activation switch;
retrieve document download instructions from a memory linked to said activation switch after receiving said prompt, said document download instructions comprising instructions for execution by a processor based device that when executed cause said device to locate a data file at a specified network address and to download said data file; and,
transmit said document download instructions from a transmitter via a wireless protocol having an operable range of not more than about 3 meters.
